(19) United States
(12) Patent Application Publication
(10) Pub. No.: US 2011/0011721 A1
(43) Pub. Date: Jan. 20, 2011

(54) Vacuum Pyrolytic Gasification And Liquefaction To Produce Liquid And Gaseous Fuels From Biomass

(76) Inventor: Gary E. Champagne, Mobile, AL (US)

Correspondence Address: WALTER W. DUFT;LAW OFFICES OF WALTER W. DUFT, 8616 MAIN ST, SUITE 2, WILLIAMSVILLE, NY, 14221, US

(21) Appl. No.: 12/838,175

(22) Filed: Jul. 16, 2010

Related U.S. Application Data
(60) Provisional application No. 61/225,999, filed on Jul. 16, 2009.

(51) Int. Cl. C10B 57/12; B01J 29/06; B01D 5/00

(52) U.S. Cl. 201/20; 502/68; 502/65; 202/96; 202/84; 202/83

(57) ABSTRACT

A biofuel production method, catalyst and system. The method may include combining a feedstock comprising a carbonaceous material with a consumable catalyst to produce a feedstock/catalyst mixture, and subjecting the feedstock/catalyst mixture to a vacuum pyrolytic gasification and liquefaction process to produce one or more biofuels. The catalyst includes effective amounts of various catalyst constituents, which may include some or all of kaolin, zeolite, amorphous silica, alumina aluminum phosphate and rare earth elements. The system may include apparatus for heating the feedstock/catalyst mixture under selected temperature and vacuum pressure conditions to produce a gaseous effluent comprising one or more hydrocarbon fractions, and additional distillation and condensation apparatus to produce one or more liquid and gaseous fuels.

### CROSS-REFERENCE TO RELATED APPLICATIONS

The present application claims the benefit under 35 U.S.C. 119(e) of U.S. Provisional Patent Application No. 61/225,999, the entire contents of which are fully incorporated herein by this reference.

### BACKGROUND

1. Field

The present disclosure relates to the production of liquid and gaseous fuels from carbonaceous materials, and more particularly to a biofuel production technique that converts biomass into one or more biofuel output products that are primarily liquid fuel forms.

2. Description of the Prior Art

By way of background, various methods have been used to convert renewable biomass feed stocks into biofuels. A first category comprises standard gasification methods that produce gaseous fuels such as methane and syngas. A second category comprises biodiesel methods that produce liquid fuel from bio-oils through the chemical process of transesterification. A third category comprises the production of liquid ethanol through a fermentation process. A fourth category comprises the production of liquid fuel through the Fischer Tropsch process using a fixed bed catalyst.

Each the foregoing methods have significant limitations that have prevented mass commercialization, or which have only been commercialized with costly economic subsidies. For example, standard gasification (syngas) only produces gaseous fuels, not liquid fuels. Liquid fuels are predominately used for transportation needs. Biodiesel production via transesterification is limited for several reasons, including high cost per gallon, the creation of a glycerol waste stream requiring disposal, and reliance on methyl alcohol in a 1:1 ratio with each gallon of biodiesel produced. Biodiesel production also relies on the use of food feed stocks in competition with human consumption. Liquid ethanol is limited by high cost per gallon and the use of food feed stocks such as corn in competition with human consumption. It is only an additive to existing petrol fuels at 10% to 15% by volume and is too low in energy content to power existing internal combustion engines as a 50% or 100% fuel source. Also, an ethanol fuel content above 15% by volume has been shown to damage present internal combustion engines which further decreases economic viability. The Fischer Tropsch process is limited by high cost per gallon and high capital cost per gallon. This method is only used in very large scale immobile plant operations. The fixed catalyst bed is also easily poisoned and polluted, and is very expensive.

### SUMMARY

A biofuel production method, a biofuel production catalyst and a biofuel production system are provided for converting biomass and other carbonaceous feedstock materials to one or more liquid biofuels that may be used to power internal combustion engines and for other energy production purposes. The feedstock is combined with a consumable catalyst and subjected to a vacuum pyrolytic gasification and liquefaction process to produce one or more biofuel end products. The constituents of the biofuel end products may include light liquid fuels having a carbon content of C7-C11 (gasoline range fuels), medium weight liquid fuels having a carbon content of C12-C15 (kerosene range fuels) and heavy liquid fuels having a carbon content of C16-C20 (diesel range fuels). Gaseous biofuels may also be produced and recovered for use.

According to an example embodiment, the biofuel production method may include combining a feedstock comprising the carbonaceous material with a consumable catalyst to produce a feedstock/catalyst mixture. The feedstock/catalyst mixture may be subjected to a vacuum pyrolytic gasification process wherein the mixture is heated under selected conditions of temperature and vacuum pressure to produce a gaseous effluent comprising one or more hydrocarbon fractions. The gaseous effluent may be subjected to a liquefaction process that includes one or more condensation operations that isolate and remove the desired liquid biofuels and any non-condensable gaseous biofuel products that remain.

An example biofuel production catalyst may comprise a zeolite material. The zeolite may be combined with a clay material, such as kaolin. Some or all of amorphous silica, alumina and aluminum phosphate may also be present. One or more rare earth elements may likewise be added. The proportions of the catalyst constituents may be varied according to the feedstock and the desired liquid biofuel fractions.

An example biofuel production system may include apparatus for processing the feedstock prior to mixing it with the consumable catalyst. This processing may be performed at ambient temperature and pressure conditions. If desired, an optional kettle operation may be performed at elevated temperature to drive off water from feedstocks that require moisture removal. A vacuum pump subsystem maintains vacuum pressure in the remainder of the biofuel production system to control the vacuum pyrolytic gasification process and to drive the gaseous effluent through the one or more condensation operations during the liquefaction process. Within the vacuum pressure environment, a catalyst feed subsystem supplies a desired amount of catalyst to the feedstock to enable the desired conversion of feedstock to biofuel. A vacuum reactor heats the feedstock/catalyst mixture under controlled conditions of temperature and vacuum pressure.

Liquefaction of the gaseous effluent produced by the vacuum reactor may include an initial condensing operation performed in a distillation tower. One or more heavy liquid fuels, such as diesel fuel, may be recovered in this manner. Further condensing may be performed by a light-medium fuel condenser whose output may be fed to a reflux drum. A portion of the light-medium liquid fuels collected in the reflux drum may be fed to the distillation tower in conventional fashion to facilitate the heavy fuel distillation operation. The remainder of the reflux drum liquid contents may be collected or may undergo further distillation, depending on the desired output product. Non-condensable gaseous fuels in the reflux drum may also be recovered.

### BRIEF DESCRIPTION OF THE DRAWINGS

The foregoing and other features and advantages will be apparent from the following more particular description of example embodiments, as illustrated in the accompanying Drawings, in which:

FIG. 1 is a schematic view showing an example biofuel production system that may be constructed in accordance with the present disclosure;

FIG. 2 is a set of distillation curves for a standard #2 commercial diesel fuel, an example diesel fuel produced in accordance with the present disclosure, and an example gasoline fuel produced in accordance with the present disclosure; and

FIG. 3 is a table showing an comparison between selected properties of standard #2 diesel fuel and two example diesel fuels produced in accordance with the present disclosure.

### DETAILED DESCRIPTION OF EXAMPLE EMBODIMENTS

### Example Biofuel Production Method

It has been discovered that liquid and gaseous biofuels may be produced from a variety of carbonaceous materials using a vacuum pyrolytic gasification and liquefaction process and a consumable catalyst that favors the production of desired biofuel output products. The technique involves combining a feedstock comprising a carbonaceous material with a consumable catalyst to produce a feedstock/catalyst mixture. The feedstock/catalyst mixture is then subjected to vacuum pyrolytic gasification and liquefaction to produce one or more biofuels, including liquid biofuels that may be used to power internal combustion engines and for other energy production purposes.

As described in more detail below, vacuum pyrolytic gasification includes heating the feedstock/catalyst mixture under controlled conditions of temperature and vacuum pressure to produce a gaseous effluent comprising one or more hydrocarbon fractions. The gaseous effluent is subjected to liquefaction, which comprises one or more condensation operations that isolate and remove desired liquid biofuel fractions. The constituents of the biofuel end products may include light liquid fuels having a carbon content of C7-C11 (gasoline range fuels), medium weight liquid fuels having a carbon content of C12-C15 (kerosene range fuels) and heavy liquid fuels having a carbon content of C16-C20 (diesel range fuels). The liquid fuel constituents may include one or more paraffins and isoparaffins (alkanes), naphthenes (cycloalkanes), olefins (alkenes), and aromatic hydrocarbons (arenes). Gaseous biofuels, such as methane, ethane, ethylene, propylene, and/or other small chain hydrocarbons in the C1-C4 range may also be produced and recovered for use.

A variety of carbonaceous materials may be used in the foregoing process, including biomass materials and non-biomass materials. Suitable biomass materials may be selected from the group consisting of oil/lipid biomass products and lignocellulosic biomass products. Oil/lipid biomass products predominately comprise triglycerides (and/or diglycerides or monoglycerides) and/or free fatty acids. Lignocellulosic biomass products predominately comprise the carbohydrate polymers cellulose and hemicellulose together with lignin. Lipids and proteins may also be present in such products. Combinations of oil/lipid biomass products and lignocellulosic biomass products may also be used, if desired. Depending on the feed materials used, the carbon content of the feedstock may range between approximately C5 to C50 or higher.

The oil/lipid biomass products may be plant or animal based. Examples of plant-based oil/lipid biomass products include (but are not limited to) algae or other aquatic species, as well as oil-containing terrestrial plants such as corn, beans, legumes, seeds, etc. Bio-oils derived from such biomass products may also be used. Examples of animal-based oil/lip biomass products include (but are not limited to) animal fats such as tallow and fish oils, as well as various fat, oil and grease waste streams, such as yellow and brown greases, sewage sludge, animal renderings, manure, etc.

The lignocellulosic biomass products are plant based. Examples include (but are not limited to) wood and gum products (forest derivatives) such as wood chips, saw dust, timber slash, mill scrap, paper products, etc., grasses, sugar crops, starch crops, grain crops, agricultural wastes such as cuttings, stalks, chaff, etc., and municipal waste such as yard clippings and waste paper. Pyrolytic oils obtained by pyrolyzing such products may also be used.

The carbonaceous materials may also include suitable non-biomass materials containing one or more hydrocarbon species. These may be selected from the group consisting of fossiliferous materials such as coal, plastic material and rubber material. These materials may be used alone or as a co-feedstock in combination with one or more biomass materials.

The one or more biofuels produced by the vacuum pyrolytic and liquefaction process disclosed herein may comprise at least one liquid biofuel and at least one gaseous biofuel. As stated above, the at least one liquid biofuel may include biofuels from the group consisting of light liquid fuels, medium weight liquid fuels and heavy liquid fuels. More particularly, the at least one liquid biofuel may be from the group consisting of gasoline fractions that are compatible for use in finished gasoline products meeting applicable requirements of the ASTM D4814 standard, diesel fractions that are compatible for use in finished diesel fuel products meeting applicable requirements of the ASTM D975 standard, and kerosene fractions that are compatible for use in kerosene jet fuel products meeting applicable requirements of the ASTM D1655 standard. The at least one one gaseous biofuel may include methane, ethane, ethylene, propylene and other gaseous hydrocarbon fractions. One or more byproducts such as nitrogen, carbon dioxide, hydrogen, oxygen and carbon monoxide may also be produced.

If desired, the feedstock may undergo water removal prior to combining it with the consumable catalyst. For example, the feedstock may be heated in a heating vessel in combination with one or more oils, fats or greases to boil off the moisture. The water removal operation eliminates or mitigates hydrolysis during subsequent processing. The residual fats, oils and greases that remain in the feedstock following dewatering can also increase the BTU content of low-energy density carbonaceous materials such as wood and other lignocellulosic biomass products.

The feedstock may be combined with the consumable catalyst at a controlled mixing ratio to enable the desired conversion into the desired fuels. By way of example, the mixing ratio of feedstock to consumable catalyst (by weight) could be as low as approximately 100:1 and as high as approximately 1000:1. Specific ratios within this range are described in more detail below in connection with specific examples. The combining of feedstock and consumable catalyst may be performed in a vacuum environment that is substantially oxygen free. This vacuum environment can be maintained throughout subsequent vacuum pyrolytic processing following the combining of feedstock and consumable catalyst. By way of example, a vacuum pressure of approximately 5-25 inches Hg (inches of mercury) may be applied. Vacuum pressures below or above this range could potentially also be used. However, lower vacuum increases the boiling point of the liquid hydrocarbon fractions, thereby requiring the use of higher temperature processing. Higher vacuum increases the draw off of gaseous fuel products, thereby decreasing liquid fuel yields.

Vacuum pyrolytic gasification comprises heating the biomass/catalyst mixture to a desired temperature while maintaining the aforesaid vacuum and the substantially oxygen-free environment. By way of example, a temperature of approximately 260-480 degrees F. may be used. Temperatures above or below this range could potentially also be used, such as if the vacuum pressure used during processing requires temperature adjustment to maintain the fuel constituents in a gaseous state. Heating the feedstock/catalyst mixture under selected conditions of temperature and vacuum pressure, as exemplified above, produces a gaseous effluent comprising one or more hydrocarbon fractions. As previously stated, the gaseous effluent may then undergo liquefaction to yield various liquid biofuel fractions. For example, a first condensing operation may be performed on the gaseous effluent to produce at least one heavy liquid fuel, such as diesel fuel. A second condensing operation may then be performed on the remaining gaseous effluent to produce at least one light liquid fuel, such as gasoline. The second condensing operation may also be used to recover at least one medium weight liquid fuel, such as kerosene/jet fuel. Alternatively, a third condensing operation could be performed between the first and second condensing operations to recover the at least one medium weight liquid fuel. Additional condensing operations may be performed as desired to recover other fractions. Alternatively, a single fractional distillation unit could be used to recover the various fractions. Other distillation techniques could potentially also be used.

Following the one or more condensing operations, there may remain at least one uncondensed gaseous liquid fuel, which may be recovered for use as a gaseous biofuel. For example, methane may be recovered as part of the gaseous biofuel output. Other gaseous hydrocarbons that may be recovered include ethane, ethylene and propylene. As previously stated, one or more byproducts such as nitrogen, carbon dioxide, hydrogen, oxygen and carbon monoxide may also be produced.

The vacuum pyrolytic gasification and liquefaction process may further produce one or more vacuum pyrolytic gasification residues during heating of the feedstock/catalyst mixture to produce the aforesaid gaseous effluent. These one or more vacuum pyrolytic gasification residues may comprise a potassium-containing compound such as potash (also referred to a potassium carbonate), which may be recovered for various uses.

### Example Consumable Catalysts

An effective consumable catalyst for used in the above-described vacuum pyrolytic gasification and liquefaction process may comprise a microporous or mesoporous aluminosilicate zeolite material. The zeolite may be combined with a clay material, such as kaolin. Amorphous silica and alumina may also be present, as well as aluminum phosphate. One or more rare earth elements may likewise be added. The proportions of the catalyst constituents may be varied according to the feedstock and the desired liquid biofuel fractions.

By way of example, the catalyst may comprise selected quantities of kaolin clay, microporous or mesoporous zeolite, amorphous silica, alumina, aluminum phosphate and one or more rare earth elements. Kaolin is a clay that typically contains 10-95% of the mineral kaolinite, which has the chemical composition Al₂Si₂O₅(OH)₄ and is composed of silicate sheets (Si₂O₅) bonded to aluminum oxide/hydroxide layers (Al₂(OH)₄). For the consumable catalyst disclosed herein, the kaolin constituent consists mainly of kaolinite. In addition to kaolinite, the kaolin may contain minor portions of other minerals, including one or more of quartz, mica, feldspar, illite, montmorillonite, ilmenite, anastase, haematite, bauxite, zircon, rutile, kyanite, silliminate, graphite, attapulgite, and halloysite. Other clays, such as bentonite, could potentially also be used. The kaolin provides a support matrix for the zeolite. The amorphous silica and alumina serve as further support binders and as reaction promoters. The aluminum phosphate acts as a desiccant. The rare earth elements impart thermal stability to the zeolite and enhance the light liquid fuel content of the biofuel output products.

For the consumable catalyst disclosed herein, zeolite having a pore size of approximately 1 nm (microporous) up to and including approximately 200 nm (mesoporous) may be used. The zeolite may have a wide range of silica-to-alumina molar ratios.

Amorphous silica is also referred to as silicon dioxide and is identified by the chemical formula SiO₂. Alumina is also referred to as aluminum oxide and is identified by the chemical formula Al₂O₃. Aluminum phosphate is identified by the chemical formula AlPO₄.

The rare earth elements that may be used in the consumable catalyst include combinations of one or more lanthanide oxides. Examples include (but are not limited to) oxides of lanthanum, cerium, neodymium, yttrium and praseodymium.

The consumable catalyst provides reaction sites of defined surface area for the disassembly of fatty acid and carbohydrate molecules within the feedstock to create the desired liquid (and gaseous) biofuels. By way of example, the makeup and proportion ranges of a consumable catalyst for use as disclosed herein may comprise (by weight) 10-80% kaolin, 5-50% zeolite, 2-30% amorphous silica, 0.0001-45% alumina, 0.001-5% aluminum phosphate and 0-10% rare earth elements. The quantities of each component may be varied according to the feedstock and the desired biofuel output. For example, increasing the zeolite and/or rare earth content contributes to increased cracking This can be useful for enhancing the production of lighter output fractions from heavier (higher carbon number) feedstocks. Conversely, decreasing the zeolite and/or rare earth content may be desirable to prevent the overcracking of lighter (lower carbon number) feedstocks. The examples described in a later section are illustrative of these principles.

### Example Biofuel Production System

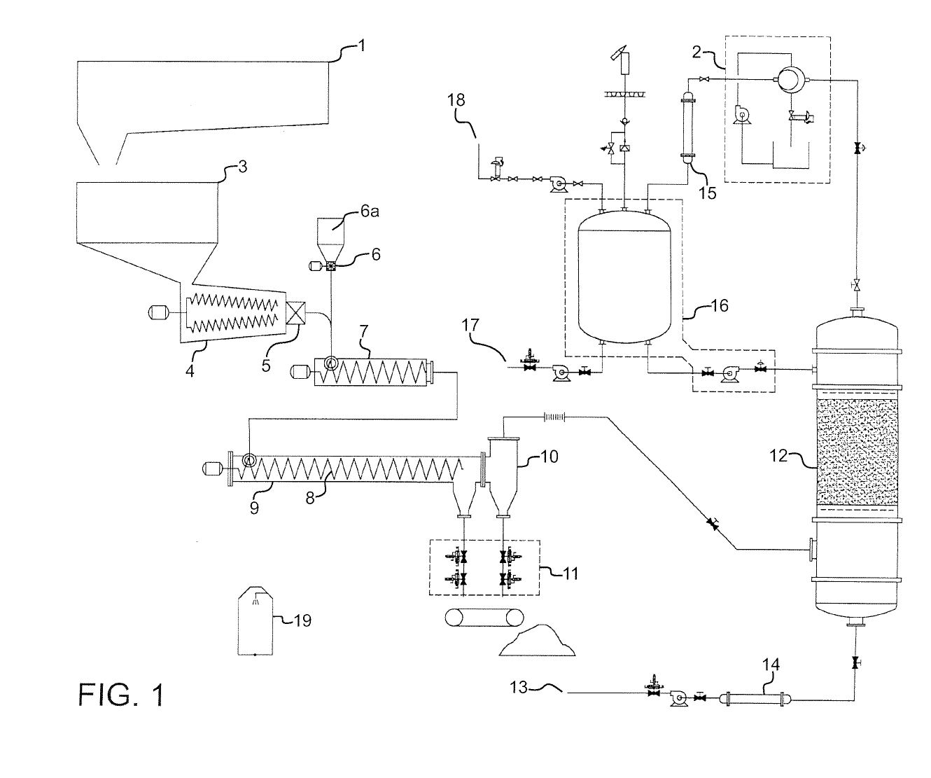

Turning now to FIG. 1, an example biofuel production system is shown. The illustrated system may be used for either batch or continuous-feed processing. The system begins with an optional feedstock preparation subsystem 1 that provides a kettle operation to dewater the carbonaceous feedstock prior to mixing it with the consumable catalyst. The kettle operation is performed at ambient pressure but at elevated temperature with the feedstock being placed in a hot bath comprising one or more hot oils, fats or greases. The hot liquid will boil off any moisture that is present in the carbonaceous feedstock. As such, the hot oils, fats or greases may be maintained at temperature above 212° F., but should not be so hot as to react any of the hydrocarbon constituents of the feedstock. By way of example, a temperature of approximately 240° F.-310° F. may be used. Following dewatering, the oils, fats and greases may be drained away. However, at least some fat-oil-grease residue will typically remain on and/or infused within the feedstock, resulting in what may be referred to as a “flocked feedstock.” De-watering the feedstock is useful for water-containing feedstocks to eliminate or mitigate hydrolysis during subsequent processing. The residual fats, oils and greases in a flocked feedstock may also increase the BTU content of low-energy density carbonaceous materials such as wood.

A vacuum pump subsystem 2 maintains vacuum pressure in the various subsystems of the biofuel production system that are used to perform vacuum pyrolytic gasification and liquefaction. During vacuum pyrolytic gasification, the vacuum (negative) pressure provides a desired reaction environment for creating the preferred reactions to convert the feedstock into desirable fuels. During liquefaction, the vacuum pressure helps move the gaseous effluent through the one or more condensing operations. As described above, a typical vacuum level held during processing may range between approximately 15-25 in. Hg., with higher or lower vacuum levels also being possible.

A feedstock hopper 3 receives the raw feedstock to be processed. If the feedstock preparation subsystem 1 is used to provide the above-described kettle operation, some or all of the raw feedstock will include flocked feedstock. The feedstock hopper 3 is sized to hold the feedstock in sufficient quantities to run the system for a predetermined length of time in continuous or batch mode. A feedstock auger 4 meters the feedstock at a controlled rate from the feedstock hopper 3 to a plug and sealing valve 5, which represents the beginning of the vacuum environment provided by the vacuum subsystem 2. The plug and sealing valve 5 enables vacuum pressure to be maintained in the downstream system components by creating a plug or seal using the feedstock material.

Within the vacuum pressure environment, a catalyst feed subsystem 6 supplies a desired amount of consumable catalyst 6A into the feedstock to maintain a precise feedstock-to-catalyst ratio. Although not shown, the catalyst feed subsystem 6 could also be located outside the vacuum environment of the disclosed biofuel production system. Maintaining a precise feedstock-to-catalyst ratio ensures that there will be just enough catalyst to fully convert all available feedstock to biofuel, thereby maximizing conversion efficiency without wasting catalyst. As previously stated, an example feedstock-to-catalyst ratio may range between approximately 100:1 to 1000:1, depending on the feedstock and catalyst materials being used. The feedstock and the consumable catalyst are combined together in an extruder 7 to produce the feedstock/catalyst mixture. The extruder 7 includes an auger that works the feedstock and consumable catalyst together while transporting it to an outlet end of the extruder. The extruder 7, which can be constructed from steel or other ferrous (or non-ferrous) alloy, may be heated to an outside temperature of between approximately 100° F.-700° F. to preheat the feedstock/catalyst mixture prior to vacuum pyrolytic gasification. The vacuum pressure in the extruder 7 is the system vacuum pressure provided by the vacuum pump subsystem 2 (e.g., between approximately 5-25 in. Hg.).

A vacuum reactor subsystem comprising an auger 8 within an elongated vacuum reactor vessel 9 (e.g., of circular cross-section) is used to heat the feedstock/catalyst mixture under controlled conditions of temperature and vacuum pressure. The temperature referred to in the preceding sentence is the temperature to which the feedstock is raised during pyrolytic gasification within the reactor vessel 9. This corresponds to the temperature of the gaseous effluent produced by such process. As previously stated, an example temperature range of approximately 260° F.-480° F. may be used for algae and wood-based feedstocks. Other temperatures may be used for other feedstocks. For example, non-biomass feedstocks such as rubber and plastic may require higher processing temperatures. As described above, processing temperature may also be impacted by the vacuum pressure, with higher temperatures being required at lower vacuum pressures to maintain heavier hydrocarbon fractions in a gaseous state until they are ready for condensation. The vacuum pressure within the reactor vessel 7 will be the system vacuum pressure provided by the vacuum pump subsystem 2 (e.g., between approximately 5-25 in. Hg.). The reactor vessel 9 (as well as the extruder 7) may be heated from the outside using various techniques, including heating with one or more electric heaters in contact with the vessel exterior, heating by flowing a hot medium (such as oil) around the vessel exterior, and heating using a direct fire method. Like the extruder 7, the reactor vessel 9 may be constructed from steel or other ferrous (or non-ferrous) alloy to ensure efficient heat transfer to the reactor interior. Insulation may be wrapped around the reactor vessel 9 (as well as the extruder 7) to improve heating efficiency. Maintaining the desired temperature within the reactor vessel 9 will typically require that the outer wall temperature be somewhat higher. For example, to achieve the example pyrolytic gasification temperature range of 260° F.-480° F., the outside wall of the reactor vessel 9 when constructed from steel may need to be heated to approximately 580° F.-950° F.

The reactor vessel 9 is where vacuum pyrolytic gasification of the feedstock is performed to produce the gaseous effluent comprising one or more hydrocarbon fractions. The reactor auger 8 receives the feedstock/catalyst mixture from the extruder 7 and moves the feedstock/catalyst mixture through the vacuum reactor vessel 9 to produce the desired reactions. The speed of the auger 8 is selected to control the dwell time of the feedstock/catalyst mixture to ensure maximum disassembly of the feedstock into the gaseous state. For example, a dwell time ranging from 10 to 40 minutes/pound of feedstock may be used for most feedstocks in order to reach the desired pyrolytic gasification temperature. Heavier (larger carbon number) feedstocks may require more dwell time than lighter (smaller carbon number) feedstocks.

The gaseous effluent produced in the reactor vessel 9 enters an expansion chamber 10 at the outlet side of the reactor vessel. The expansion chamber 10 may be heated to ensure that the effluent remains in a gaseous state. The auger 8 also removes inorganic particulates from the reactor vessel 9 in the form of an ash by-product by pushing it into an ash dump system 11 for extraction. This pyrolytic gasification residue comprises potash, a potassium-containing compound that may be recovered for use.

Liquefaction of the gaseous effluent produced by vacuum pyrolytic gasification within the reactor vessel 9 begins downstream of the expansion chamber 10. There are many ways in which liquid recovery may be performed to obtain desired hydrocarbon fractions from the gaseous effluent. In general, any of the recovery techniques used for fossiliferous petroleum refining will be applicable. The system 1 depicts one example liquid recovery embodiment wherein the gas stream from the reactor vessel 9 is drawn by the vacuum pump subsystem 2 into a distillation tower 12 to undergo an initial condensing operation. The distillation tower 12 is a conventional reflux-assisted distillation/condensation unit. By controlling the temperature within the distillation tower 12 (taking into account the vacuum pressure therein), the initial condensation operation may be set up so that heavy liquid fuel, such as diesel fuel in the C16-C20 range, condenses at the bottom of the distillation tower 12. This fuel may be recovered at a heavy fuels outlet 13 following optional cooling by a liquid cooler 14. Although not shown, further condensation/distillation of the heavy fuel output obtained from the heavy fuels outlet 13 may be performed to further isolate desired hydrocarbon fractions.

Medium and light hydrocarbon fractions of the gaseous effluent that do not condense to liquid form may be drawn out the top of the distillation tower 12 by the vacuum pump subsystem 2. Secondary condensing may be performed by a medium/light fuel condenser 15 to produce one or more medium and/or light liquid fuels. Again, the temperature may be controlled to condense the desired fraction(s). The condensed liquids and various non-condensable gases may be fed to a reflux system 16 comprising a reflux drum. The reflux drum helps separate the medium and/or light liquid fuel fractions from the non-condensable gaseous fuels. The medium and/or light liquid fuel fractions collect at the bottom of the reflux drum. A portion of these liquids may be pumped back to the distillation tower 12 as a cold reflux fluid to assist the primary condensing operation. The remaining medium and/or light liquid fractions at the bottom of the reflux drum may be collected at a medium-light fuels outlet 17. Depending on the setup of the condenser 15, these fuels may comprise medium weight liquid fuels in the C12-C15 range (e.g., kerosene/jet fuel) and light liquid fuels in the C7-C11 range (e.g., gasoline). C5-C6 naphthas may also be recovered. Although not shown, additional condensing and/or distilling may be performed to further isolate desired liquid fuel fractions. Non-condensable gaseous fuels in the C1-C4 range (e.g., methane) reflux drum may be recovered at a gaseous fuel outlet 18 and stored for use/sale or flared.

A system chiller or cooling tower 19 provides the necessary cooling capacity to the heavy liquid fuels cooler 14 and the liquid fuels condenser 15. A control system (not shown) is also provided to control system operations. The control system may be implemented as a fully automated process that proceeds using feedback control based on process sensors to maintain the desired process control settings. The control feedbacks include vacuum level, liquid levels, temperature, flow rate, and velocity. Vacuum level is measured at the reactor vessel 9 and the vacuum subsystem 2. Liquid levels are measured in the distillation tower 12 and the reflux subsystem 16. Temperature is measured in the extruder 7, the reactor vessel 9, the distillation tower 12 and the piping between expansion chamber 10 and distillation tower 12. Temperature is also measured at the liquid fuels condenser 15. Flow rate is measured in the reflux system 16. Velocity measurement is optional for the gaseous exits of the distillation tower 12 and the expansion chamber 12.

If desired, the biofuel production system 1 may be configured as a portable apparatus. For example, the system 1 may be sized so that it can be carried on one or two flat bed trailers for transportation to a feedstock site, such as a feedstock production facility. In this configuration, the system may be expected to produce a maximum daily biofuel output of approximately 30,300 gallons or more per day. This is sufficient for many biofuel production applications.

### WORKING EXAMPLES

### Example 1

For this example, the feedstock was comprised of a 50/50 mix (by weight) of dried salt water algae and flocked wood comprising pine saw dust (⅜ in. particle size or less) and FOG (fats, oils, greases) in the form of yellow grease. The algae had a 40% lipid content largely comprising C16 and C18 fatty acid groups. The wood-FOG mixture contained (by weight) 60% wood and 40% FOG, with the latter containing heavy chains up to C46. This mixture was prepared by combining the saw dust with heated yellow grease in the feedstock preparation subsystem 1. Following dewatering, the excess grease was removed, leaving the flocked feedstock component with a 60% wood/40% FOG weight ratio. Forty-five (45) pounds of the dried algae was combined with forty-five (45) pounds of the flocked wood-FOG mixture to produce 90 pounds of feedstock. The feedstock mixture had a water content of less than 5% water content and an energy content of 11,500-13,000 BTU per pound.

The consumable catalyst used for this example was comprised (approximately) of 12% Kaolin, 28.2% zeolite, 28.2% silicon dioxide (amorphous), 28.2% aluminum oxide as Al(2)O(3), 2.5% aluminum phosphate and 1% rare earth elements. The amount of catalyst mixed with the 90 pounds of feedstock was 0.36 pounds. Thus, the catalyst content by weight was 4,000 parts per million or 0.4% of the feedstock/catalyst mixture. This represents a feedstock-to-catalyst weight ratio of 250:1.

The process parameters used for this example were as follows:
Reactor vessel skin temperature: 668° F.-681° F. range; 670.4° F. average;
System vacuum: 13 to 15 inches Hg range; 14.8 inches Hg average;
Reactor vessel auger speed: 0.75 pound/minute feed rate;
Total Processing time: 120 minutes;
Gaseous effluent temperature: 334° F.-433° F. range; 397° F. average;

The output products for this example were comprised of 10 pounds of ash (11.1% conversion to ash), 22 pounds of syngas (24.4% conversion to syngas) and 58 pounds of liquid fuel (64.4% conversion to liquid). The energy content of the syngas was 665.8 BTU per cubic foot at normal temperature and pressure (NTP). The constituents of the syngas included approximately 34.6% N₂ with the balance of the syngas being a mix of methane (CH₄), ethane (C₂H₆), ethylene (C₂H₄) and propylene (C₃H₆), together with byproducts of hydrogen (H₂), oxygen (O₂), carbon dioxide (CO₂) and carbon monoxide (CO). The energy content of the liquid fuel was 16,500 BTU per pound, which is 125,000 BTU per gallon. The weight percentages of the various hydrocarbon species were (approximately) 14.2% paraffins and isoparaffins, 19.9% naphthenes, 35.2% olefins and 30.7% aromatics.

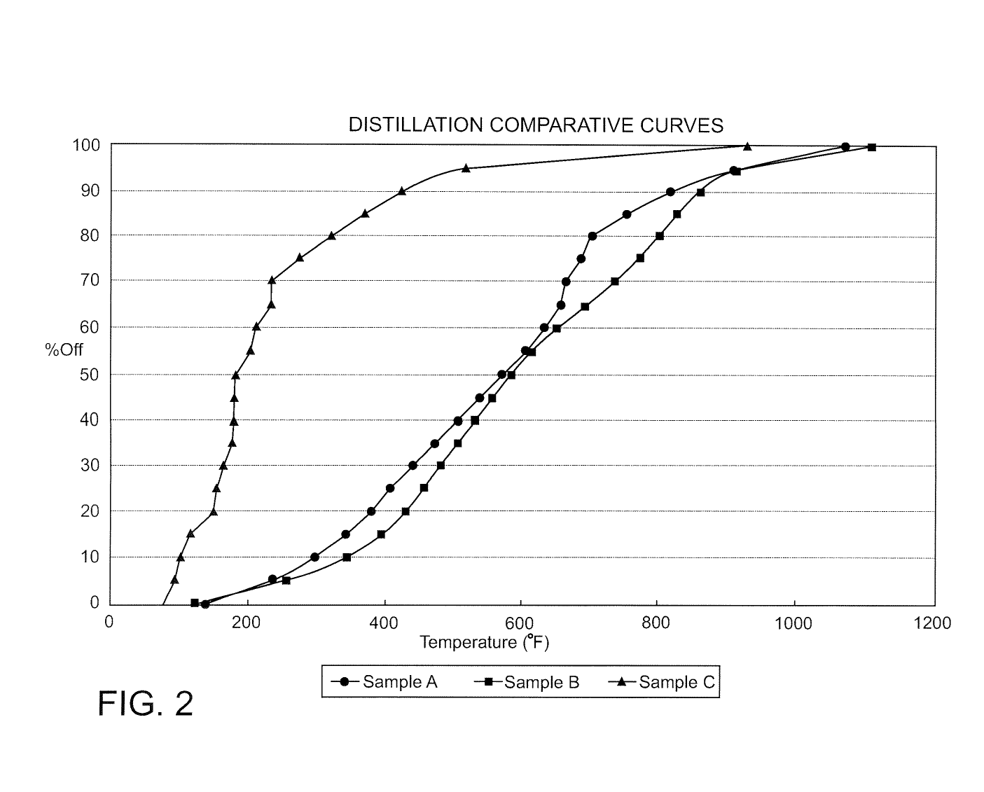

A first condensation operation was used to produce a diesel weight fuel product and a second condensation operation was used to produce a gasoline weight fuel product. Distillation curves for these fuel products (based on gas chromatography analysis) are shown in FIG. 2. These curves plot the percentage of boil-off (shown on the Y-axis) versus temperature (shown on the X-axis) as the liquid fuel products products are heated until they are fully vaporized. The distillation curve for Sample A corresponds to the diesel fuel product. The distillation curve for Sample B corresponds to commercial #2 diesel fuel. The distillation curve for Sample C corresponds to the gasoline fuel product. As can be seen, the diesel fuel product of Sample A corresponds very closely to the commercial diesel fuel of Sample B. Similarly, the gasoline fuel product of Sample C contains the fractions that are normally found in commercial gasoline. The results of FIG. 2 indicate that the diesel fuel product of Sample A is compatible for use in a diesel fuel product meeting the ASTM D975 standard. Similarly, the gasoline fuel product of Sample C would be compatible for use in a for use in a gasoline product meeting the ASTM D4814 standard. As used herein, “compatible for use” includes using the fuel product by itself or combining it with one or more additives as may be required by the applicable standard. As will be seen below in Table 1, the liquid fuel output of this experiment could have also been distilled to produce a medium weight kerosene fuel product that is compatible for use in a jet aviation fuel conforming to the ASTM D1655 standard.

A C5-C50 breakdown of the paraffinic component of the entire liquid fuel output produced by this example is shown below in Table 1. As can be seen, the major fractions fall within the gasoline (C7-C11), kerosene (C12-C15) and diesel (C16-C20) ranges, with substantial additional fractions falling between C20-C24. Minor portions of heavier fractions from C25-C46 were also present.

TABLE 1
Example 1-C5—C20 Quantification of Paraffinic Component of Liquid Fuel

| | |
|---|---|
| n-Pentane (C5 and its isomers) | 0% |
| n-Hexane (C6 and its isomers) | 0.28% |
| n-Heptane (C7 and its isomers) | 2.55% |
| n-Octane (C8 and its isomers) | 3.77% |
| n-Nonane (C9 and its isomers) | 4.60% |
| n-Decane (C10 and its isomers) | 4.74% |
| n-Undecane (C11 and its isomers) | 4.97% |
| n-Dodecane (C12 and its isomers) | 5.15% |
| n-Tridecane (C13 and its isomers) | 4.32% |
| n-Tetradecane (C14 and its isomers) | 4.52% |
| n-Pentadecane (C15 and its isomers) | 4.24% |
| n-Hexadecane (C16 and its isomers) | 4.04% |
| n-Heptadecane (C17 and its isomers) | 4.06% |
| n-Octadecane (C18 and its isomers) | 2.73% |
| n-Nonadecane (C19 and its isomers) | 3.26% |
| n-Eicosane (C20 and its isomers) | 6.99% |
| n-Heneicosane (C21 and its isomers) | 8.15% |
| n-Docosane (C22 and its isomers) | 8.64% |
| n-Tricosane (C23 and its isomers) | 2.80% |
| n-Tetracosane (C24 and its isomers) | 2.33% |
| n-Pentacosane (C25 and its isomers) | 1.71% |
| n-Hexacosane (C26 and its isomers) | 1.47% |
| n-Heptacosane (C27 and its isomers) | 1.17% |
| n-Octacosane (C28 and its isomers) | 0.98% |
| n-Nonacosane (C29 and its isomers) | 0.87% |
| n-Triacontane (C30 and its isomers) | 0.82% |
| n-Hentriacontane (C31 and its isomers) | 0.76% |
| n-Dotriacontane (C32 and its isomers) | 0.60% |
| n-Tritriacontane (C33 and its isomers) | 0.71% |
| n-Tetratriacontane (C34 and its isomers) | 0.64% |
| n-Pentatriacontane (C35 and its isomers) | 0.92% |
| n-Hexatriacontane (C36 and its isomers) | 0.69% |
| n-Heptatriacontane (C37 and its isomers) | 0.82% |
| n-Octatriacontane (C38 and its isomers) | 0.56% |
| n-Nonatriacontane (C39 and its isomers) | 0.52% |
| n-Tetracontane (C40 and its isomers) | 0.53% |
| n-Hentetracontane (C41 and its isomers) | 0.56% |
| n-Dotetracontane (C42 and its isomers) | 0.56% |
| n-Tritetracontane (C43 and its isomers) | 0.54% |
| n-Tetratetracontane (C44 and its isomers) | 0.51% |
| n-Pentatracontane (C45 and its isomers) | 0.48% |
| n-Hexatetracontane (C46 and its isomers) | 1.43% |
| n-Heptatetracontane (C47 and its isomers) | 0% |
| n-Octatetracontane (C48 and its isomers) | 0% |
| n-Nonstetracontane (C49 and its isomers) | 0% |

### Example 2

For this example, two feedstocks were run with the same catalyst. A first feedstock comprised 100% dried salt water algae. A second feedstock was comprised of a 25/75 mix (by weight) of dried salt water algae and flocked wood comprising 60% pine saw dust (⅜ in. particle size or less) and 40% FOG in the form of yellow grease. The flocked wood feedstock component was prepared in the same manner as example 1. Sixty (60) pounds of each feedstock was used. Thus, the first feedstock comprised sixty (60) pounds of algae and the second feedstock comprised thirty-six (36) pounds of saw dust and twenty-four (24) pounds of FOG.

The consumable catalyst used for this example was comprised (approximately) of 12% Kaolin, 28% zeolite, 28% silicon dioxide (amorphous), 28% aluminum oxide as Al(2)O(3), 2.5% aluminum phosphate and 1.5% rare earth elements. The amount of catalyst mixed with the 60 pounds of feedstock was 0.24 pounds. Thus, the catalyst content by weight was the same as in Example 1, namely, 4,000 parts per million or 0.4% of the feedstock/catalyst mixture, which represents a feedstock-to-catalyst weight ratio of 250:1.

Each of the first and second feedstocks was separately processed in two runs using the same process parameters as in Example 1. The first feedstock run yielded 2 pounds of ash, 42 pounds of liquid fuel and a balance of 16 pounds of methane/syngas. The second feedstock run yielded 6 pounds of ash, 41 pounds of liquid fuel and a balance of 13 pounds of methane/syngas.

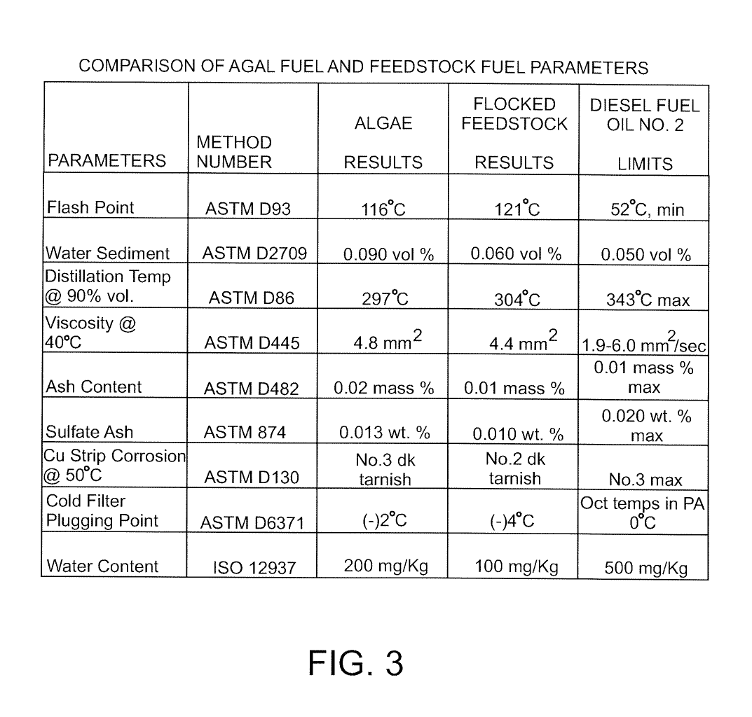

The liquid output of each run in this example was condensed to produce diesel fuel output products. Various parameters of these diesel fuel products were then tested using ASTM methods in order to compare the products to commercial #2 diesel fuel. The results of this testing are shown in the table of FIG. 3. The analysis of FIG. 3 is recognized to be the ASTM D6751 test protocol for determining diesel fuel quality. The column labeled “Parameters” specifies the parameter being tested. The column labeled “Method Number” identifies the ASTM test method that was used. The column labeled “Algae Results” shows the test results for the run based on the first (algae only) feedstock. The column labeled “Flocked Feedstock” shows the test results for the run based on the second (flocked) feedstock. The column labeled “Diesel Fuel Oil No. 2” shows the applicable ASTM ranges for commercial #2 diesel fuel.

The results shown in FIG. 3 confirm the following:
1. The flash point readings for both runs indicate high fuel quality in terms of lower levels of volatile organic contaminants;
2. The water sediment levels indicate higher levels of suspended inorganics, which can be treated with suitable pre-filtration;
3. The distillation temperature readings indicate good quality fuel content;
4. The kinematic viscosity readings were within normal limits of 1.9-6.0 min²/sec;
5. The ash content readings showed that the inorganic salt levels in each sample were close to normal limits;
6. The sulfated ash readings indicate that both fuel samples showed lower levels of heavy metal salts;
7. The Cu strip corrosion results indicate that both samples were within corrosivity limits as related to cuprous metal corrosion;
8. The cold filter plugging point readings showed that both fuel samples are less vulnerable to waxy solids plugging at lower temperatures; and
9. The water content readings for both fuel samples indicate good lubricity with lower levels of water present.

It will thus be seen that both of the input feedstocks of this example produced acceptable diesel fuel products. The test results indicate that these diesel fuels are compatible for use in a diesel fuel product meeting the ASTM D975 standard. By performing further distillation/condensation of the gaseous effluent of this example, it is expected that kerosene/jet fuel and gasoline products could be produced that would be respectively compatible for use in a jet fuel product meeting the ASTM D1655 standard and for use in a gasoline product meeting the ASTM D4814 standard.

Accordingly, a biofuel production method, a biofuel production catalyst and a biofuel production system have been disclosed. While various embodiments have been described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. A biofuel production method, comprising:
combining a feedstock comprising a biomass material with a consumable catalyst to produce a feedstock/catalyst mixture;
subjecting said feedstock/catalyst mixture to a vacuum pyrolytic gasification and liquefaction process to produce one or more biofuels.

2. The method of claim 1, wherein said vacuum pyrolytic gasification and liquefaction process comprises heating said feedstock/catalyst mixture under selected conditions of temperature and vacuum pressure to produce a gaseous effluent comprising one or more hydrocarbon fractions.

3. The method of claim 1, wherein said vacuum pyrolytic gasification and liquefaction process comprises heating said biomass/catalyst mixture to a temperature of between approximately 260-480 degrees F.

4. The method of claim 1, wherein said vacuum pyrolytic gasification and liquefaction process comprises vacuum pressurizing said biomass/catalyst mixture at a vacuum pressure of approximately 5-25 inches Hg.

5. The method of claim 2, wherein said vacuum pyrolytic gasification and liquefaction process further comprises subjecting said gaseous effluent to condensing to produce said one or more liquid biofuels.

6. The method of claim 5, wherein said condensing comprise primary condensing of said gaseous effluent to produce at least one heavy liquid fuel.

7. The method of claim 5, wherein said condensing comprises secondary condensing of said gaseous effluent to produce at least one light or medium weight liquid fuel.

8. The method of claim 7, wherein said at least one uncondensed gaseous liquid fuel remains after said secondary condensing.

9. The method of claim 1, wherein said biomass material is selected from the group consisting of oil/lipid biomass products, lignocellulosic biomass products and combinations thereof.

10. The method of claim 9, wherein:
said oil/lipid biomass products are selected from the group consisting of plant-based oil/lipid biomass products including algae or other aquatic species, corn, beans, legumes, and seeds, and animal-based oil/lipid biomass products including animal fats, tallow, fish oils, and fat, oil and grease waste streams including yellow and brown greases, sewage sludge, animal renderings and manure; and
said lignocellulosic biomass products are selected from the group consisting of wood and gum products (forest derivatives) including wood chips, saw dust and timber slash, mill scrap, paper products, grasses, sugar crops, starch crops, grain crops, agricultural wastes including cuttings, stalks, and chaff, and municipal waste including yard clippings and waste paper.

11. The method of claim 1, wherein said carbonaceous material comprises a non-biomass material containing one or more hydrocarbon species.

12. The method of claim 11, wherein said non-biomass material is selected from the group consisting of fossiliferous material, plastic material and rubber material.

13. The method of claim 1, wherein said consumable catalyst comprises a zeolite catalyst.

14. The method of claim 1, wherein said consumable catalyst comprises a zeolite/clay catalyst.

15. The method of claim 1, wherein said consumable catalyst comprises kaolin, zeolite, amorphous silica and alumina.

16. The method of claim 1, wherein said consumable catalyst further includes one or both of aluminum phosphate and rare earth elements.

17. The method of claim 1, wherein said consumable catalyst comprises (by weight) 10-80% kaolin, 5-50% zeolite, 2-30% amorphous silica, 0.0001-45% alumina, 0.001-5% aluminum phosphate and 0-10% rare earth elements.

18. The method of claim 17, wherein said zeolite has a pore size of 1 nm to 200 nm.

19. The method of claim 1, wherein said consumable catalyst is selected according to said feedstock and desired species of said one or more biofuels.

20. The method of claim 1, wherein said one or more biofuels comprise at least one liquid biofuel.

21. The method of claim 20, wherein said one or more biofuels comprise hydrocarbon species from the group consisting of paraffins and isoparaffins, naphthenes, olefins and aromatics.

22. The method of claim 20, wherein said at least one liquid biofuel comprises fuels selected from the group consisting of light liquid fuels having a carbon content C7-C11 (gasoline range fuels), medium weight liquid fuels having a carbon content of C12-C15 (kerosene range fuels) and heavy liquid fuels having a carbon content of C16-C20 (diesel range fuels).

23. The method of claim 20, wherein at least one liquid biofuel is selected from the group consisting of light liquid fuel, medium weight liquid fuel and heavy liquid fuel.

24. The method of claim 23, wherein said at least one liquid biofuel is selected from the group consisting of gasoline, diesel fuel and jet fuel.

25. The method apparatus of claim 24, wherein said at least one biofuel comprises diesel fuel.

26. The method of claim 25, wherein said diesel fuel is compatible for use in a diesel fuel product meeting the ASTM D975 standard.

27. The method of claim 24, wherein said at least one liquid biofuel comprises gasoline.

28. The method of claim 27, wherein said gasoline is compatible for use in a gasoline fuel product meeting the ASTM D4814 standard.

29. The method of claim 24, wherein said at least one liquid biofuel comprises jet fuel.

30. The method of claim 29, wherein said jet fuel is compatible for use in a jet fuel product meeting the ASTM D1655 standard.

31. The method of claim 1, wherein said one or more biofuels comprise at least one one gaseous biofuel.

32. The method of claim 31, wherein said at least one gaseous biofuel comprises one or more of methane, ethane, ethylene and propylene.

33. The method of claim 1, wherein said feedstock undergoes water removal prior to said combining with said consumable catalyst.

34. The method of claim 1, wherein said feedstock/catalyst mixture comprises a feedstock-to-catalyst weight ratio of approximately 100:1 to 1000:1.

35. The method of claim 1, wherein said vacuum pyrolytic gasification and liquefaction process further produces one or more vacuum pyrolytic gasification residues.

36. The method of claim 35, wherein said one or more vacuum pyrolytic gasification residues comprise a potassium-containing compound.

37. The method of claim 36, wherein said potassium-containing compound comprises potash.

38. The method of claim 1, wherein said method is carried out in a portable apparatus.

39. The method of claim 1, wherein said method produces a maximum daily output of said one or more biofuels of approximately 30,300 gallons or more.

40. A consumable catalyst for use in producing one or more biofuels from a carbonaceous material, comprising approximately (by weight) 10-80% kaolin, 5-50% zeolite, 2-30% amorphous silica, 0.0001-45% alumina, and 0.001-5% aluminum phosphate.

41. The consumable catalyst of claim 40, further including 0-10% rare earth elements.

42. The consumable catalyst of claim 41, wherein said one or more biofuels comprises commercial grade diesel fuel and gasoline, and said catalyst comprises approximately (by weight) 12% kaolin, 28.2% zeolite, 28.2% amorphous silica, 28.2% alumina, 2.5% aluminum phosphate and 1% rare earth elements.

43. The consumable catalyst of claim 41, wherein said one or more biofuels comprises commercial grade diesel fuel and said catalyst comprises approximately (by weight) 12% kaolin, 28% zeolite, 28% amorphous silica, 28% alumina, 2.5% aluminum phosphate and 1.5% rare earth elements.

44. A biofuel production system, comprising:
feedstock handling subsystem for handling a feedstock comprising a biomass material prior to mixing said feedstock with a consumable catalyst;
a combining and mixing subsystem operable to combine and mix said feedstock with said consumable catalyst to produce a feedstock/catalyst mixture;
a vacuum pyrolytic gasification subsystem operable to process said feedstock into a gaseous effluent comprising one or more hydrocarbon fractions; and
a liquefaction subsystem operable to condense said gaseous effluent into one or more liquid and gaseous biofuels.

45. The system of claim 44, wherein said feedstock handling subsystem comprises a feedstock hopper, a feedstock auger and a feedstock plug and sealing valve.

46. The system of claim 45, wherein said feedstock handling subsystem further comprises a feedstock preparation subsystem operable to perform a kettle operation at elevated temperature to drive off water from said feedstock.

47. The system of claim 44, further including a vacuum pressure subsystem comprises a vacuum pump subsystem operable to generate vacuum pressure to control vacuum pyrolytic gasification and to drive said gaseous effluent through one or more condensation stations that perform liquefaction.

48. The system of claim 47, wherein said combining and mixing subsystem comprises a consumable catalyst feeder operable to meter catalyst into said feedstock at in a controlled ratio to support conversion of said said feedstock to biofuel, and an extruder for mixing said feedstock and said catalyst to produce said feedstock/catalyst mixture.

49. The system of claim 48, wherein said vacuum pyrolytic gasification subsystem comprises a vacuum reactor operable to heat said feedstock/catalyst mixture under controlled conditions of temperature and vacuum pressure to produce said gaseous effluent.

50. The system of claim 49, wherein said liquefaction subsystem comprises a distillation tower operable to perform a first condensing operation that condenses at least one of said one or more gaseous intermediate into one at least one heavy liquid fuel.

51. The system of claim 50, wherein said liquefaction subsystem further comprises a liquid fuels condenser operable to receive said gaseous effluent that does not condense in said distillation tower and to condense said gaseous effluent into at least one medium weight or light liquid fuel.

52. The system of claim 51, wherein said liquefaction subsystem further comprises a reflux subsystem operable to separate said at least one medium weight or light liquid fuel from non-condensable fuels of said gaseous effluent for separate recovery of said medium weight or light liquid fuel and said non-condensable fuels.

53. The system of claim 52, wherein said reflux subsystem is further operable to return a portion of said medium weight or light liquid fuel to said distillation tower to assist condensing therein.

54. The system of claim 44, wherein said system is a portable apparatus.

55. The system of claim 44, wherein said system is operable to produces a maximum daily output of said one or more biofuels of approximately 30,300 gallons or more.
